(19) United States
(12) Patent Application Publication
(10) Pub. No.: US 2026/0087647 A1
(43) Pub. Date: Mar. 26, 2026

(54) Efficient Video Prediction using Motion Graph

(71) Applicant: Microsoft Technology Licensing, LLC, Redmond, WA (US)

(72) Inventors: Yiqi ZHONG, Seattle, WA (US); Luming LIANG, Redmond, WA (US); Ilya Dmitriyevich ZHARKOV, Niwot, CO (US)

(73) Assignee: Microsoft Technology Licensing, LLC, Redmond, WA (US)

(21) Appl. No.: 18/894,848

(22) Filed: Sep. 24, 2024

(51) Int. Cl. G06T 7/246; G06T 3/40

(52) U.S. Cl. CPC G06T 7/248; G06T 3/40; G06T 2207/10016; G06T 2207/20081; G06T 2207/20084

(57) ABSTRACT

A video prediction technique generates a motion graph based on given video frames. The motion graph includes spatial edges and temporal edges. Each spatial edge describes a same-frame semantic relationship between two graph nodes that are associated with a same video frame. Each temporal edge describes an interframe relationship between two graph nodes of temporally neighboring frames. The temporal edges include backward temporal edges and forward temporal edges. The technique further includes generating initial motion feature information associated with the graph nodes in the plural given video frames, and updating the motion feature information by performing message-passing operations. The technique decodes the motion feature information into dynamic vector information. The technique then predicts and synthesizes a subsequent video frame based on the given video frames and the dynamic vector information.

### BACKGROUND

The task of video prediction involves predicting future frames of a sequence of video frames based on given previous video frames. Current techniques for performing this task suffer from one or more drawbacks. For instance, some techniques produce inaccurate predictions, particularly when interpreting complex video content, such as motion blur. In addition, or alternatively, some techniques rely on large complex models, and/or consume a large amount of processing and memory resources during their execution.

### SUMMARY

A prediction technique is described herein that generates a motion graph based on given video frames. The technique predicts and synthesizes a subsequent video frame based on the plural given video frames and the motion graph.

According to some implementations, the motion graph includes plural graph nodes that represent image patches in the given video frames. The motion graph also includes spatial edges and temporal edges. Each spatial edge describes a same-frame semantic relationship between two graph nodes that are associated with a same video frame. Each temporal edge describes an interframe relationship between two graph nodes of temporally neighboring video frames.

In some implementations, the temporal edges include backward temporal edges and forward temporal edges. Each backward temporal edge describes a semantic relationship between a particular graph node in a particular given video frame and a graph node in a temporally preceding video frame. Each forward edge describes a semantic relationship between the particular graph node in the particular given video frame and a graph node in a temporally succeeding video frame.

In some implementations, for the particular graph node, the technique identifies k spatial edges, k backward temporal edges, and k forward temporal edges. k is a prescribed integer. The k edges correspond to those patch-to-patch semantic relationships that exhibit the greatest similarity.

In some implementations, the technique further includes generating initial motion features associated with the graph nodes in the plural given video frames. The technique then updates the motion features by performing message-passing operations among the graph nodes. The motion features are collectively referred to herein as motion feature information.

In some implementations, the technique performs prediction by decoding the motion feature information associated with the graph nodes into dynamic vector information. The technique then applies video warping to predict the subsequent video frame based on the given video frames and the dynamic vector information.

In some implementations, the dynamic vector information includes, for a particular source pixel under consideration associated with a particular given video frame, k dynamic vectors, where k is a prescribed integer. Each dynamic vector connects the particular source pixel with a particular target pixel in the subsequent video frame.

According to illustrative technical merits, the motion graph describes complex many-to-many patch-to-patch relationships. This increases the accuracy of the technique relative to other prediction techniques, particularly when complex video content is encountered, such as motion blur or distortion due to perspective projection. The technique is also implementable using a model that is more compact and resource efficient compared to other techniques.

The above-summarized technology is capable of being manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 shows a computing system that includes a predicting system for performing video prediction, and a training system for training the predicting system.

FIG. 2 shows an overview of a motion graph produced by the predicting system of FIG. 1, and the use of the motion graph to predict a subsequent video frame.

FIG. 3 shows an overview of one manner of operation of the predicting system of FIG. 1.

FIG. 4 is a demonstration of how an image encoder creates plural feature maps.

FIG. 5 shows one implementation of the image encoder of FIG. 4.

FIG. 6 shows one implementation of a down-sample component, which is used in the image encoder of FIG. 5.

FIG. 7 shows logic for generating initial motion features associated with the graph nodes of the motion graph.

FIG. 8 shows an interaction component for updating the motion features associated with the graphs nodes by performing message-passing operations.

FIG. 9 shows one implementation of a spatial update operation performed by the interaction component of FIG. 8.

FIG. 10 shows one implementation of a temporal update operation performed by the logic of FIG. 8.

FIG. 11 shows one implementation of a pipeline that produces motion feature information and then uses the motion feature information to predict a subsequent video frame.

FIG. 12 shows an example of a warping operation performed by the pipeline of FIG. 11

FIG. 13 shows logic that implements an up-sampling operation in the pipeline of FIG. 11 using plural up-sampling blocks. FIG. 13 also shows a decoding operation performed by the pipeline of FIG. 11.

FIG. 14 shows one implementation of an individual up-sample block of the logic shown in FIG. 13.

FIG. 15 shows a training component for producing weights which govern the operation of the predicting system of FIG. 1.

FIG. 16 is a chart showing the accuracy of the predicting system of FIG. 1, relative to the accuracy of other prediction techniques.

FIG. 17 is a chart showing the resource efficiency of the predicting system of FIG. 1, compared to the resource efficiency of other prediction techniques.

FIG. 18 is a flowchart that shows an overview of the operation of the predicting system of FIG. 1.

FIG. 19 is a flowchart that shows an overview of a graph-creating operation performed by the predicting system of FIG. 1.

FIG. 20 is a flowchart that describes how the predicting system of FIG. 1 maps motion feature information into dynamic vector information, and then uses the dynamic vector information to predict a subsequent video frame.

FIG. 21 shows computing equipment that, in some implementations, is used to implement the computing system of FIG. 1.

FIG. 22 shows an illustrative type of computing system that, in some implementations, is used to implement any aspect of the features shown in the foregoing drawings.

The same numbers are used throughout the disclosure and figures to reference like components and features.

### DETAILED DESCRIPTION

### A. Overview

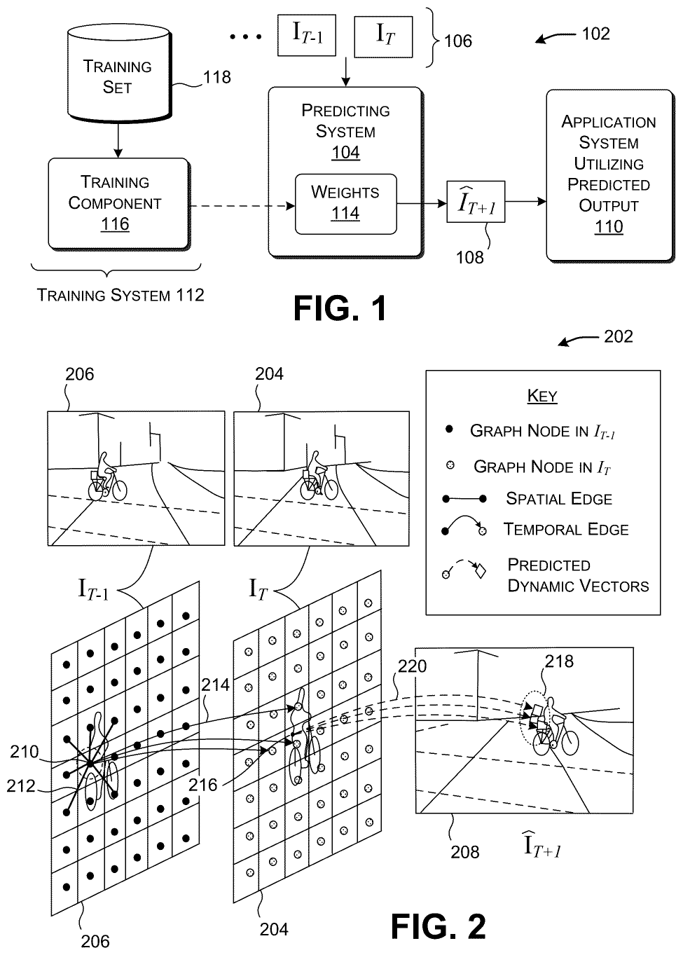

FIG. 1 shows a computing system 102 that includes a predicting system 104 for predicting and synthesizing future video frames given T video frames, where T is any two or more video frames (henceforth, simply “frames”). In the specific case of FIG. 1, the predicting system 104 receives at least a last frame I_{T} and its preceding frame I_{T-1}. The predicting system 104 generates a motion graph having graph nodes (henceforth “nodes”) that represent image patches in the frames 106, and edges that represent semantic relationships among the image patches. The predicting system 104 then uses the motion graph to predict a frame Î_{T+1} 108 that follows the last frame I_{T}. In some applications, the predicting system 104 repeats this process to predict additional future frames (Î_{T+2}, Î_{T+3}, etc.), e.g., by treating each synthesized frame as a given frame.

In some cases, the predicted frame 108 is a frame that has not yet been captured or received. In other applications, the predicting system 104 predicts a frame that already exists based on prior frames in a sequence, e.g., for the purpose of disambiguating video content in that existing frame. Generally, Iₜ refers to a particular frame in a sequence of T frames.

An optional application system 110 performs an application-specific action based on the precited frame(s). One application system uses the predicting system 104 to identify actions that a subject shown in video information is about to take. A surveillance system, for instance, may use the predicting system 104 to help track a subject throughout a series of frames. Another application system uses the predicting system 104 to reduce bandwidth in the transmission of video content. A video conferencing application, for instance, predicts every third frame in a video stream, given the previous two frames. This eliminates the need to transmit the third frame, and thus reduces bandwidth in the transmission of the video content. Another application system uses the predicting system 104 to assist a robot in interacting with its environment. A robot, for instance, uses the predicting system 104 to anticipate the movement of objects in its environment and its own movement. Another application system uses the predicting system 104 to correct errors and artifacts in frames, and so on.

A training system 112 trains weights 114 that govern the operation of the predicting system 104. In operation, a training component 116 predicts a future frame based on a sequence of frames provided in a data store 118. The training component 116 generates loss information based on an assessed difference between the predicted future frame and a ground-truth actual next frame (which is given by the training set). The training component 116 then modifies the weights 114 with the aim of reducing subsequently-assessed differences between predicted frames and actual ground-truth frames.

FIG. 2 is an example 202 that highlights some of the characteristics of the motion graph and a warping operation. Assume that the predicting system 104 receives a given sequence of frames, including a last frame I_{T} 204 in the sequence and a preceding frame I_{T-1} 206. For example, the last frame 204 may correspond to a last-captured or last-received frame. These two frames (204, 206) show a person riding a bicycle at different points along a city road. Although not shown, the frames may contain other objects in movement, such as automobiles and pedestrians. The predicting system 104 uses these frames (204, 206) to generate a motion graph, and then leverages the motion graph to predict a future frame Î_{T+1} 208. In this future frame 208, the person riding the bicycle has progressed further along a path of traversal, compared to the person's position in the frame 204.

The predicting system 104 produces the motion graph by associating nodes with respective image patches, where each image patch represents a portion of a particular frame. The predicting system 104 then generates a matching score that reflects the extent of semantic similarity between each pair of patches. In some implementations, the predicting system 104 performs this task by determining the distance between instances of feature information associated with the pair, e.g., using a cosine similarity metric or any other distance metric (e.g., a Manhattan difference, Euclidean distance, Minkowski distance, and/or Jaccard distance). The predicting system 104 then establishes edges on the basis of the matching scores. As will be described in greater detail below, the predicting system 104 actually establishes plural sets of edges for different feature representations of the patches, but this complexity is omitted at this juncture in the explanation.

More specifically, consider a particular node 210 associated with a particular image patch in the frame 206. The predicting system 104 identifies k spatial edges that connect this particular node to neighboring nodes in the same frame. The neighboring nodes are selected because they are associated with k image patches that have the strongest semantic relationships with the particular image patch under consideration. A spatial edge 212 is an example of this category of edges.

The predicting system 104 also identifies k forward temporal edges that connect the particular node to neighboring nodes in the next frame 204. The neighboring nodes in the next frame 204 are selected because they are associated with k image patches that are most semantically related to the particular image patch under consideration in the frame 206. A forward temporal edge 214 is an example of this category of edges. Although not shown in FIG. 2, the predicting system 104 identifies k backward temporal edges that connect the particular node under consideration to neighboring nodes in a frame that precedes the frame 206. Further note that, in the above implementation, the predicting system 104 chooses the same number (k) of spatial edges, forward temporal edges, and backward temporal edges. But this need not be the case; other implementations choose different prescribed numbers of edges for different respective categories of edges. In some examples, k is an integer between (or equal to) 5 and 15, although other implementations choose other values of k. Note that, in some implementations, each temporal edge connects nodes in two immediately adjacent frames.

In the prediction phase of operation, the predicting system 104 decodes motion feature information associated with the nodes into dynamic vector information. The dynamic vector information includes instructions for mapping pixels in each given frame to locations in the future frame 208. For example, consider a pixel location 216 in the given frame 204. The predicting system 104 generates k dynamic vectors that point from this pixel location 216 to potentially different pixel locations 218 in the future frame 208. A dynamic vector 220 is one example of this set of dynamic vectors. More formally stated, the dynamic vector information for a frame t is expressed as:

$${P}_{t , x , y} = [ ( Δ {x}_{1} , Δ {y}_{1} , {w}_{1} ) , … ( Δ {x}_{k} , Δ {y}_{k} , {w}_{k} ) ] . \qquad ( 1 )$$

In this equation, each instance dynamic vector i includes a positional offset Δxᵢ, Δyᵢ that maps a source pixel location (x,y) in the frame t to a target pixel location in the next frame 206. wᵢ represents a weight associated with the dynamic vector. Although FIG. 2 shows an example in which dynamic vectors emanate from a single frame 204, more generally, any source pixel in any given frame is capable of contributing to a target pixel in the future frame 208, based on a dynamic vector that describes that contribution. The number of dynamic vector per pixel (k) is equal to the number of edges in different categories, but other implementations need not adhere to this choice of hyper-parameters.

The predicting system 104 then forward-warps the dynamic vector information and the given frames 106 into the future frame 108. As will explained below in greater detail, one implementation of this warping uses a splatting-based implementation that determines the composition of each pixel in the future frame 208 based on a weighted contribution from plural source pixels in the given frames. The following equation represents the warping operation:

$${\hat{I}}_{T} = \vec{𝒲} ( P , {I}_{0} , … , {I}_{T - 1} ) . \qquad ( 2 )$$

In this equation, P is the dynamic feature information, I₀, . . . , I_{T-1} are the given frames, and [symbol] represents the warping operation.

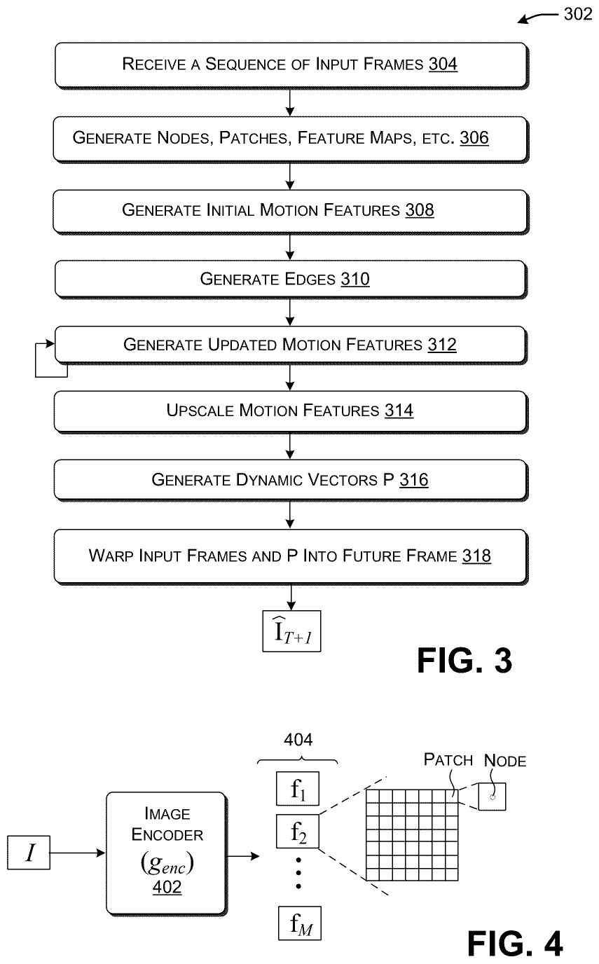

FIG. 3 shows a process 302 that provides an overview of one manner of operation of the predicting system 104 of FIG. 1. In block 304, the predicting system 104 receives a sequence of two or more given frames.

In block 306, the predicting system 104 uses an image encoder g_{enc} to generate M feature maps [symbol] ={f^{t,(1)}, f^{t,(2)}, . . . , f^{t,(M)}} associated each frame t. m denotes a particular feature map in the M feature maps. For example, the encoder produces M feature maps for each frame having different respective scales, which are then reshaped so that they have the same resolution. The predicting system 104 also partitions each given frame (and the feature maps associated with this frame) into a plurality of patches, for instance, each having a size of 10 pixels by 10 pixels. The predicting system 104 also associates a node with each image patch. [symbol] represents the set of nodes (and corresponding patches) across all of the frames. The reshaping of the feature maps to the same resolution is performed so there is an equal number of nodes and patches across all feature maps.

In block 308, the predicting system 104 generates initial motion features associated with the nodes, with respect to each feature representation m of the input frames. As will be described below, this process involves generating a tendency vector and a location vector for each node, for each feature representation, which are subsequently concatenated together to form the motion feature associated with the node. Each tendency vector captures a node's motion-related attributes relative to nodes in the subsequent frame. Each location vector represents the absolute location of each node in a frame.

In block 310, the predicting system 104 generates edges that connect the nodes together. As described above, this process involves using a distance metric of any type (e.g., cosine similarity) to assess the difference between pairs of image patches. For any given node under consideration, the generated edges include k spatial edges, k forward temporal edges, and k backward temporal edges. Generally, it is useful to capture spatial relations because neighboring image patches in a frame sometimes influence each other's future motion. Backward and forward temporal edges reveal potential motion paths. The predicting system 104, however, does not assign backward edges to the first frame in the series of given frames, and does not assign forward edges to the last frame in the series of given frames.

More specifically, the predicting system 104 generates M sets of edges (ε⁽¹⁾, ε⁽²⁾, . . . , ε^{(M)}) associated with the M different feature representations of the input frames. That is, ε^{(m)}={ε^{(m)}, ε^{B(m)}, ε^{F(m)}}, where ε^{S(m)} represents the k spatial edges, ε^{B(m)} represents the k backward edges, and ε^{F(m)} represents the k forward edges across the frames, with respect to a feature representation m. Altogether, the motion graph is expressed as [symbol] ={ [symbol] , ε⁽¹⁾, . . . , ε^{M}}. An m^{th} view of the motion graph focuses on relationships among the nodes defined by a particular set of edges ε^{m} with respect to the feature representation m. To simplify explanation at this juncture, however, assume that the motion graph includes a single set of edges associated with a single view.

In block 312, the predicting system 104 updates the motion features associated with the nodes by iteratively performing message-passing operations among the nodes of the graph. The motion features are collectively referred to as motion feature information below.

In block 314, the predicting system 104 upscales the motion feature information to the size of the original given frames. Note that this upscaling operation is preceded by a fusing operation, which merges separate instances of motion feature information associated with different respective graph views. Further note that that operations that precede the upscaling operation are performed on a node level, whereas operations that follow the upscaling operation are performed on a pixel level.

In block 316, the predicting system 104 decodes the upscaled motion feature information to produce dynamic vector information P. The dynamic source information includes k dynamic vector per pixel in each given frame. Each dynamic vector specifies how a source pixel in a given frame maps to a target pixel in the future frame being predicted. In block 318, the predicting system 104 warps the given frames and dynamic vector information P into the future frame Î_{T+1}.

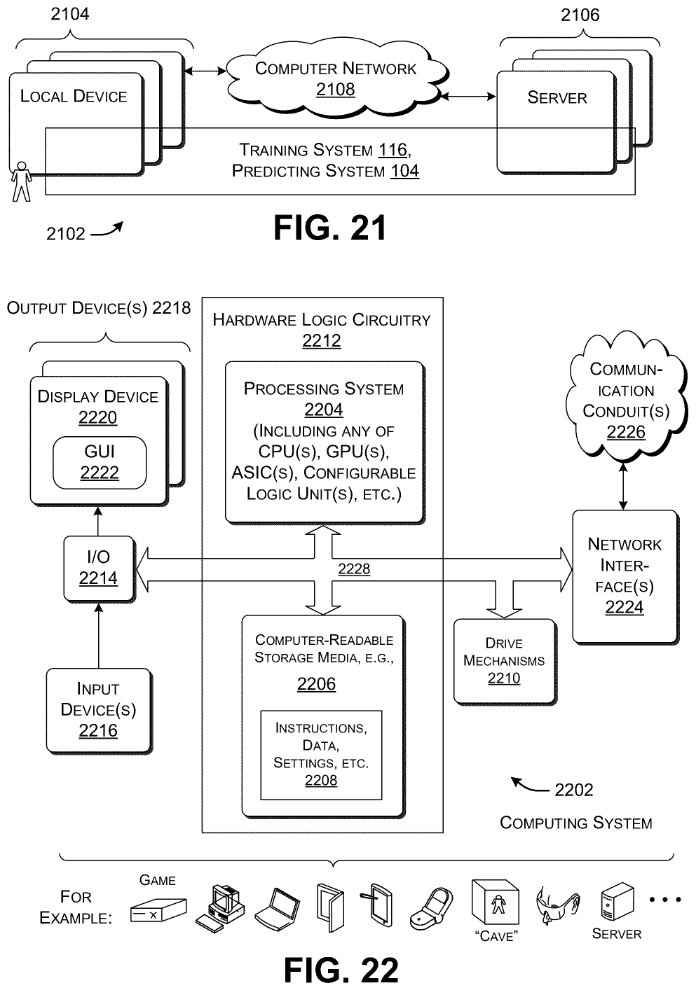

Later sections provide additional details regarding the operations of FIG. 3. By way of terminology, a “machine-trained model” or “model” refers to computer-implemented logic for executing a task using machine-trained weights that are produced in a training operation. A given video frame is a frame that exists at the outset of analysis, e.g., because it is explicitly received or captured. Synthesis means generating image content given source image content. In some contexts, terms such as “component,” “module,” “engine,” and “tool” refer to parts of computer-based technology that perform respective functions. FIGS. 21 and 22, described below, provide examples of illustrative computing equipment for performing these functions.

### B. Generating the Motion Graph

FIG. 4 provides further details regarding block 306 of the process 302 of FIG. 3. In this step, an image encoder 402 maps each frame t into M different feature maps 404 ( [symbol] ={f^{t,(1)}, f^{t,(2)}, . . . , f^{t,(M)}}) associated with different scales. The predicting system 104 also reshapes each feature map to the resolution of the feature map having the smallest scale. Assume that the resolution of the smallest feature map generated by the image encoder 402 is H_{S}×W_{S}. The predicting system 104 also partitions each feature map into H_{S}×W_{S} patches. In other implementations, the predicting system 104 performs its analysis with respect to a single feature representation and a corresponding single set of edges

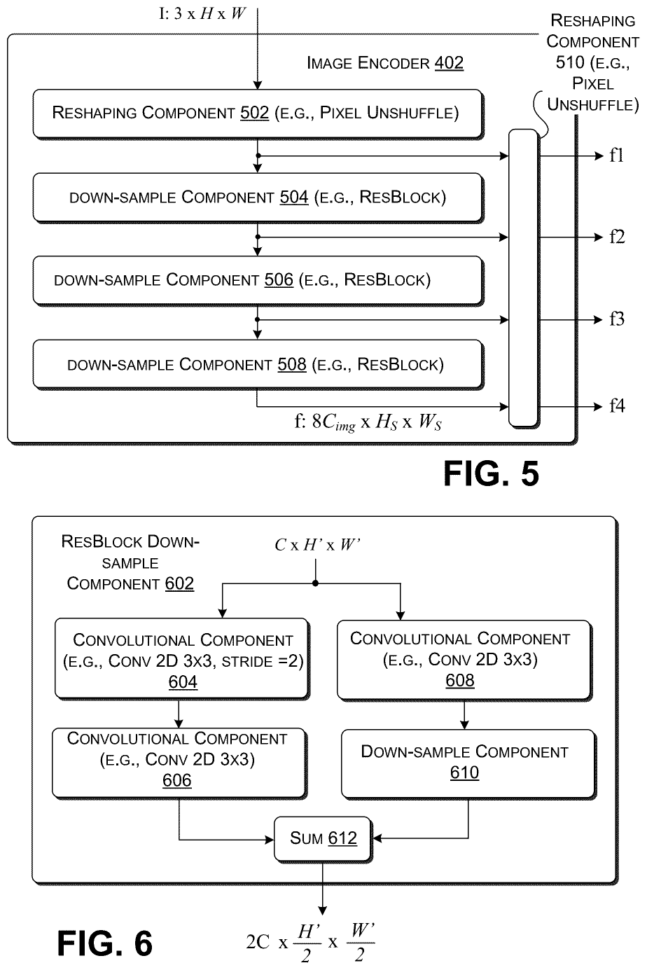

FIG. 5 describes one implementation of the image encoder 402 of FIG. 3. The image encoder 402 includes a reshaping component 502 followed by three down-sample components (504, 506, 508). The reshaping component decreases the height and width of input image content, while increasing the channels of the input image content. Each down-sample component further decreases the resolution of the image that is fed to it, while increasing the number of channels by a factor of 2. Hence, the encoder can be generally said to progressively decrease the resolution of the image that is fed to it.

The output of each component of the encoder 540 constitutes a feature map. In this example, there are four such feature maps (e.g., M=4). A final reshaping component 510 reshapes the feature maps so that they all have the same resolution (H_{S}×W_{S}) as the feature map produced by the last down-sample component 518. Note that this reshaping otherwise does not change the fact that each feature map expresses objects in the frames of different respective sizes. In some implementations, each feature map includes H_{S}×W_{S} patches per frame, and T×H_{S}×W_{S} patches over the entire series of T frames. In other words, each element of a feature map constitutes a patch, to which a node is assigned.

In one implementation, the reshaping component 502 is implemented by a pixel unshuffle operation, which decreases the height and width of input image content, while increasing the channels of the input image content. The unshuffle operation includes a pixel rearrangement that produces the reshaping, and is described at Shi, et al., “Real-Time Single Image and Video Super-Resolution Using an Efficient Sub-Pixel Convolutional Neural Network,” in Proceedings of the IEEE Conference on Computer Vision and Pattern Recognition, 2016, pp. 1874-1883. Further, the PyTorch Foundation provides an unshuffle function in its public library of functions. Although not shown, the unshuffle operation is followed by a convolutional operation, which reshapes the output of the unshuffle operation so that it has a prescribed number of channels C_{img}, e.g., 16 channels.

In some implementations, each down-sample component is implemented as a residual network block (ResBlock). FIG. 6 shows an illustrative ResBlock down-sample component 602. The left branch of the ResBlock down-sample component 602 includes a convolutional component 604 (e.g., a 2D convolutional component with a filter size of 3×3 and a stride of 2), followed by another convolutional component 606 (e.g., a 2D convolutional component with a filter size of 3×3). The right branch of the ResBlock down-sample component 602 includes a convolutional component 608 (e.g., a 2D convolutional component with filter size of 3×3), followed by a down-sample component 610. A summation component 612 sums the outputs generated by the left and right branches. As shown, the ResBlock down-sample component 602 increases by the channels in the input image by a factor of 2, while decreasing the width and the height of the input image by a factor of 2. In some implementations, each convolutional layer incorporates a Leaky ReLU activation layer.

Other implementations perform the operations of the image encoder 402 using different logic than that described above. For example, other implementations combine two or more components described above into a single component. Alternatively, or in addition, other implementations use different types of components than those set forth above, e.g., using interpolation components to replace one or more of the components shown in FIGS. 5 and 6.

### C. Generating Motion Features Using the Motion Graph

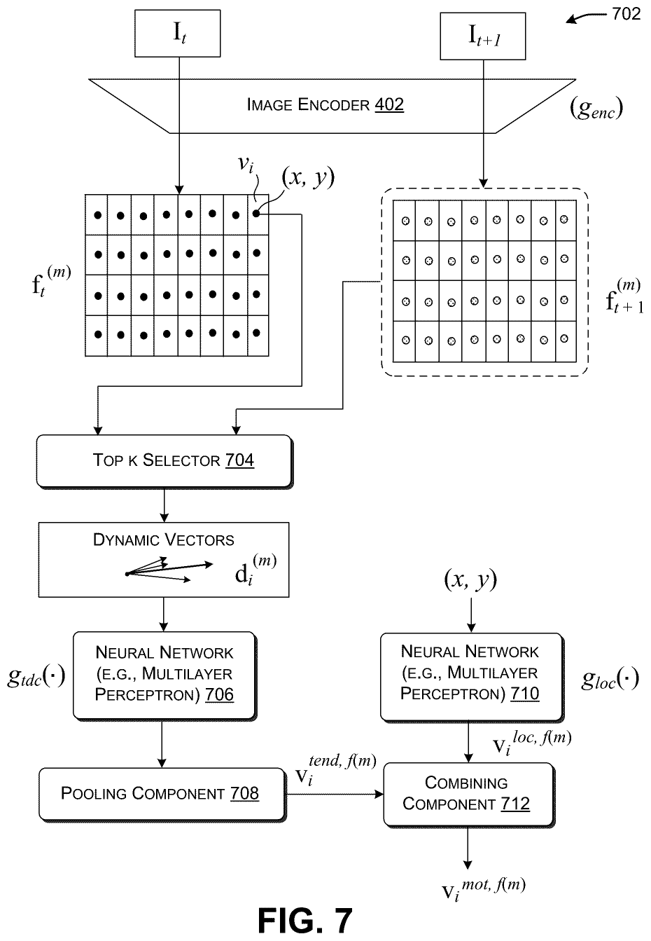

FIG. 7 shows logic 702 that performs block 308 of the process 302 of FIG. 3. This step involves generating initial motion features associated with the nodes of the motion graph. Assume that the image encoder 402 (of FIGS. 3 and 4) maps a with frame Iₜ to a first feature map

$${f}_{t}^{( m )}$$

and maps a frame Iₜ₊₁ to a feature map

$${f}_{t + 1}^{( m )} ,$$

with respect to the same feature representation m (which corresponds to a particular scaling level). FIG. 7 shows the specific case in which the task is to determine the initial motion feature

$${v}_{i}^{mot , f ( m )}$$

for a node vᵢ at a particular location (x,y) in the feature map

$${f}_{t}^{( m )} ,$$

associated with a particular patch. More generally, the predicting system 104 performs the same operation for all of the M feature maps and for all of the nodes.

A top-k selector 704 uses any distance metric (such as cosine similarity) to determine the similarity between the patch in

$${f}_{t}^{( m )}$$

associated with the node vᵢ with every patch in

$${f}_{t + 1}^{( m )} .$$

The top-k selector 704 mien selects the k patches in

$${f}_{t + 1}^{( m )}$$

that are the best matches for the patch associated with vᵢ in

$${f}_{t}^{( m )} .$$

The selection of semantically relevant patches helps mitigate the risk of false positives and enables effective interpretation of complex motion patterns.

The predicting system 104 then generates a dynamic vector di for the node vᵢ, as given by [Δx₁, Δy₁, w₁, . . . , Δxₖ, Δyₖ, wₖ], where Δxⱼ, Δyⱼ indicates the positional offset associated with each matching pair of patches, and wⱼ is the matching score (e.g., cosine similarity score) for the matching pair of patches. In the last frame, however, the predicting system 104 applies zero padding to the dynamic vectors, as I_{T} is unknown at this juncture.

A neural network 706 (e.g., a multi-layer perceptron) performs a transformation (g_{tdc}(·)) of the dynamic vector, to produce an output result. A pooling component 708 performs max-pooling on the output result, e.g., by selecting the part of the output result having the maximum value. This yields the tendency vector

$${v}_{i}^{tend , f ( m )}$$

for node vᵢ. The combined effect of these two stages of operations is described by:

$${v}_{i}^{tend , f ( m )} = {φ}_{agg} ( {g}_{tdc} ( {d}_{i}^{( m )} ) ) . \qquad ( 3 )$$

g_{tdc}(.) represents the transformation performed by the neural network 706, while φ_{agg} represents the max-pooling operation performed by the pooling component 708. The size of the initial motion feature is C_{node}, which represents the combined length of the tendency vector and the location vector.

Another neural network 710 (e.g., a multi-layer perceptron) transforms the position (x,y) of the node vᵢ to a location vector

$${v}_{i}^{loc , f ( m )} ,$$

as given by:

$${v}_{i}^{loc , f ( m )} = {g}_{loc} ( \frac{x}{{H}_{S}} , \frac{y}{{W}_{S}} ) . \qquad ( 4 )$$

H_{S} and W_{S} represent the size of the feature map f^{t,(m)}. Dividing x and y by H_{S} and Wₛ, respectively, has the effect of normalizing the absolute position (x,y). Finally, a combining component 712 combines (e.g., concatenates) the tendency vector with the location vector to produce the initial motion feature vᵢ^{mot,f(m)} for the node vᵢ.

As mentioned above, each tendency vector captures a node's motion-related attributes relative to nodes in the subsequent frame. Each location vector represents the relative location of each node in a frame. It is useful to capture location information because pixel position influences motion patterns. For instance, pixels on the sides of a frame may appear to move differently than pixels in the center of the frame due to perspective projection effects.

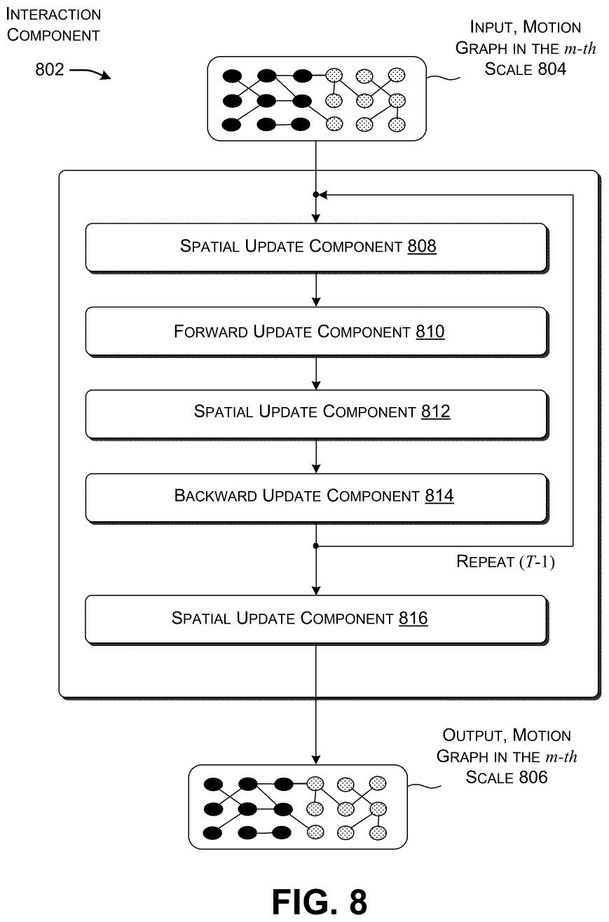

FIG. 8 shows an interaction component 802 for updating the motion features of the graph via message-passing operations. Message passing involves updating the state of a given node based on the state of at least one other node. Repeating this operation for all nodes has the effect of propagating information through a graph, as the neighborhood of nodes that contribute to a node under analysis becomes increasingly more encompassing.

In the context of FIG. 8, the message-passing operations are described with respect to a particular feature representation m, but the predicting system 104 more generally performs this updating operation for all of the feature maps. At the beginning of the process, the motion features are the initial motion features described by Equation (4). The following equation describes the updating operation:

$${v}^{′ ( m )} = {g}_{mp} ( {v}^{( m )} , {ε}^{{in}^{( m )}} ) . \qquad ( 5 )$$

v′^{(m)} represents the updated motion features and v^{(m)} represents the motion features prior to the update operation. In the context of FIG. 8, the motion graph 804 represents the motion features at the beginning of the updating process, and the motion graph 806 represents the updated motion features at the end of the updating process. εⁱⁿ^{^{(m)}} represents an edge set for the feature representation m.

In some implementations, the interaction component 802 updates different categories of edges in a particular order, which ensures balanced and holistic dissemination of motion information throughout the motion graph. For instance, a spatial update component 808 first updates motion features for nodes connected via spatial edges. A forward update component 810 next updates motion features for nodes connected via forward edges. Another spatial update 812 component again updates motion features of nodes connected via the spatial edges. A backward update component 814 then updates motion features of nodes connected via backward edges. The interaction component 802 repeats this series of operations T−1 times, where T is the number of frames. This ensures that even the first given frame is allowed to affect the frame being predicted. A final spatial update component 816 updates motion features for edges connected via the spatial edges.

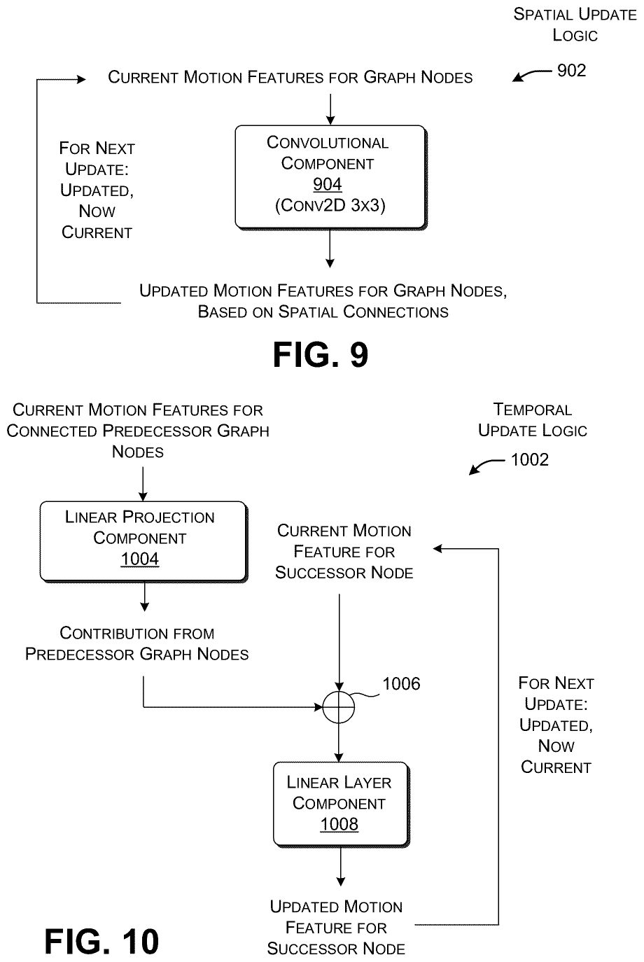

FIG. 9 shows spatial update logic 902 for updating motion features along spatial edges, as performed by each of the spatial update components (808, 812, 816) of FIG. 8. The spatial update operation involves converting current motion feature information to updated motion feature information, as guided by the spatial connections among the nodes. In some implementations, the conversion is performed using a convolutional component 904 (e.g., a 2D convolutional component with a filter size of 3×3).

FIG. 10 shows one implementation of temporal update logic 1002 for updating motion features connected by temporal edges, as performed by each of the forward update component 810 and the backward update component 814. The successor node refers to a node that is being updated in a particular frame. In the context of forward updating, a predecessor node is a node in a prior frame with respect to the frame of the node being updated. In the context of backward updating, the predecessor node is a node in a subsequent frame with respect to the frame of the node being updated. A linear component 1004 collects contributions of motion vector information from all the predecessor nodes with respect to a successor node under consideration. A concatenation component 1006 combines this contribution with the current motion feature of the successor node. A linear layer component 1008 updates the motion feature for the successor node based on the output of the concatenation component 1006.

### D. Applying the Motion Graph to Perform Video Prediction

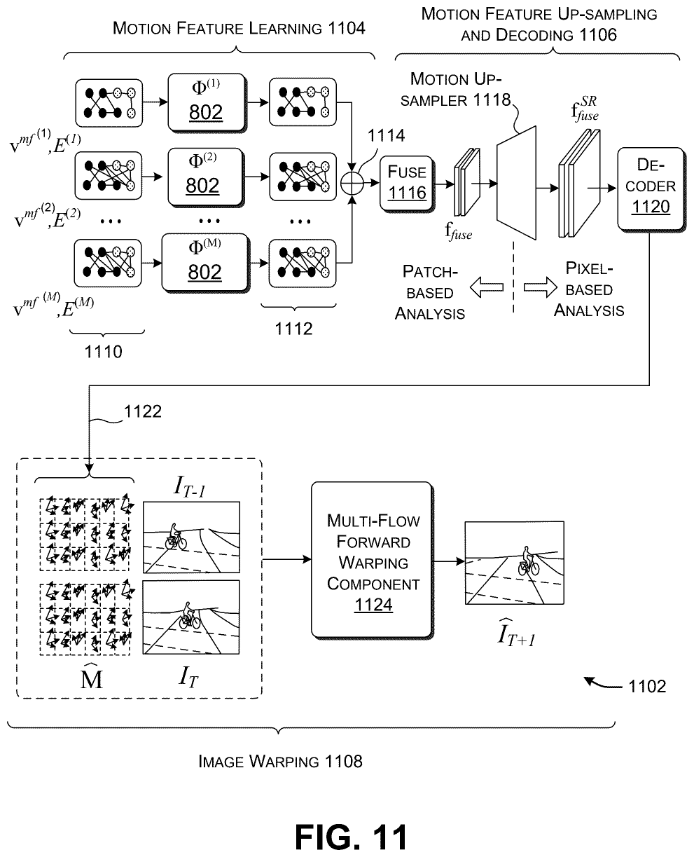

FIG. 11 shows one implementation of a pipeline 1102 that produces motion feature information and then uses the motion feature information to predict a subsequent frame. The process includes three main stages. In a first stage 1104, the predicting system 104 updates the motion feature information using the interaction component of FIG. 8. In a second stage 1106, the predicting system 104 combines the results of the previous stage, up-samples the combined results, and produces dynamic vector information based on the results of the up-sampling operation. In a third stage 1108, the predicting system 104 warps the dynamic vector information and the given frames into a predicted frame Î_{T+1}.

With respect to the first stage 1104, assume that, at this juncture, the predicting system 104 has generated plural views of the motion graph, each associated with a different set of edges for a particular feature representation m. Further assume that the predicting system 104 has generated initial motion features 1110 for the nodes in each graph view in the manner described above. The interaction component 802 then updates the motion features of each graph view in the manner described above, to produce updated motion features 1112. A concatenation component 1114 concatenates the updated motion features 1112 expressed in the different graph views.

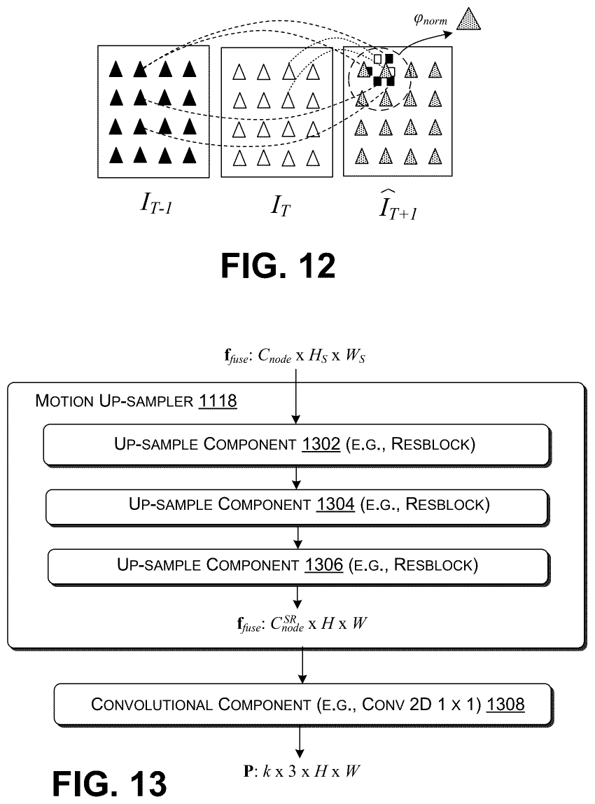

With respect to the second stage 1106, a fusion component 1116 transforms the concatenated graph views into a 2D structure with a resolution of H_{S}×W_{S}. Fusion includes any merging function(s) combined with a reshaping function. In one example, for instance, the fusion component 1116 includes a convolutional component that reduces the number of columns in the concatenated graph views (where the concatenation component 1114 had previously increased the number of channels). A motion up-sampler 1118 then update-samples the 2D structure to match the resolution of the original frames (H×S). As will be described with respect to FIGS. 12 and 13, some implementations of the motion up-sampler 1118 perform up-sampling in a progressive manner using a succession of ResNet blocks. A decoder component 1120 then converts the up-sampled motion information into dynamic vector information 1122. As previously described, the dynamic vector information includes k dynamic vectors per pixel in each given frame. In some implementations, the decoder component 1120 is implemented by a convolutional component.

With respect to the third stage 1108, a multi-flow forward-warping component 1124 (henceforth “warping component”) forward warps the dynamic vector information 1122 and the given frames to the predicted frame. In the simplified example of FIG. 11, there are two given frames (I_{T-1}, I_{T}), but the predicting system 104 is able to produce dynamic vector information for any number of given frames (providing that there are at least two given frames).

FIG. 12 shows an example of the forward warping operation performed by the warping component 1124. The black triangles represent source pixels in the frame Î_{T-1}, each of which is associated with a dynamic vector pointing to a particular target pixel in the predicted frame Î_{T+1}. Each dynamic vector also has a weight associated with it. Similarly, the white triangles represent source pixels in the frame Î_{T}, each of which is associated with a dynamic vector pointing to a particular target pixel in the predicted frame Î_{T+1}. The dashed arrows represent the connections between each source pixel and each target pixel, as specified by the dynamic vectors. As previously mentioned, other implementations include additional given frames. Generally, any pixel in any given frame is capable of contributing to a target pixel in a predicted frame, based on instructions given by a dynamic vector.

With respect to the predicted frame Î_{T+1}, any given target pixel may receive contributions from zero, one, or more source pixels. The warping component 1124 governs how these contributions combine to influence the value of the target pixel. In some implementations, the warping component 1124 determines a normalized weight based on the original weights of the dynamic vectors which point to the target pixel. That is, the warping component 1124 divides each individual weight by the sum of the weights that contribute to a target pixel. The warping component 1124 then generates a weighted sum of the values of the source pixels which contribute to the target pixel, using the normalized weights. This process is performed for other target pixels in the predicted frame to thereby predict and synthesize the content of the future frame. Normalization more readily ensures balanced contribution to the target pixel value in the predicted frame. Other implementations use other synthesis functions than the weight-averaging function described above. For instance, other implementations use a softmax function to combine the contributions of plural source pixels.

The above-described operation is a version of image splatting. General background information on the use of forward warping via splatting can be found in Niklaus, et al., “Softmax Splatting for Video Frame Interpolation,”, in Proceedings of the IEEE/CVF Conference on Computer Vision and Pattern Recognition, 2020, pp. 5437-5446, and Niklaus, et al., “Splatting-based Synthesis for Video Frame Interpolation,” in Proceedings of the IEEE/CVF Winter Conference on Applications of Computer Vision, January 2023, pp. 713-723.

Other implementations perform the operations shown in the pipeline 1102 of FIG. 12 using different logic than that described above. For example, other implementations combine two or more components described above into a single component (e.g., a single neural network) which performs the functions of the two or more components, e.g., in a consolidated manner without necessarily discriminating between the different functions.

FIG. 13 shows logic that implements the motion up-sampler 1118 of the pipeline 1102 of FIG. 11. The motion up-sampler 1118 performs up-sampling in a series of stages using plural respective up-sample components (1302, 1304, 1306). In some implementations, each up-sample component is implemented by a ResBlock. Overall, the motion up-sampler 1118 transforms input image content having a resolution of H_{S}×W_{S} to output content having the resolution of the original frames (H×W). FIG. 13 also indicates that the decoder component 1120 of FIG. 11 is implemented by a convolutional component 1308 (e.g., a 2D convolutional component with a filter size of 1×1).

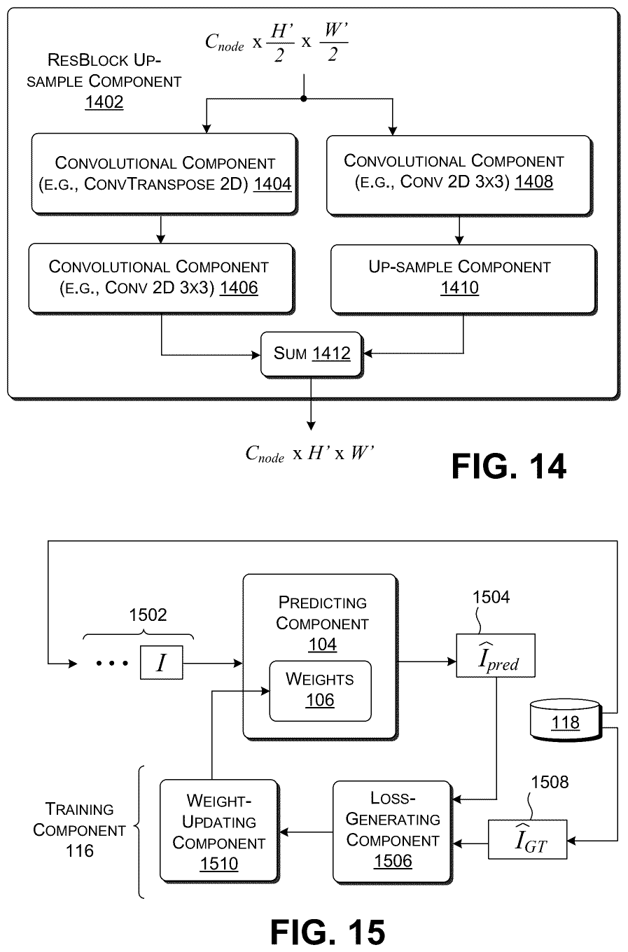

In some implementations, each up-sample component is implemented as a residual network block (ResBlock). FIG. 14 shows an illustrative ResBlock up-sample component 1402. The left branch of the motion up-sampler 1118 includes convolutional component 1404 (e.g., a 2D transposed convolutional component), followed by another convolutional component 1406 (e.g., a 2D convolutional component with a filter size of 3×3). A transposed convolutional component maps input content to output content having a larger size than the input content. The right branch of the ResBlock up-sample component 1402 includes a convolutional component 1408 (e.g., a 2D convolutional component with a filter size of 3×3), followed by an up-sample component 1410. A summation component 1412 sums the outputs generated by the left and right branches. As shown, the ResBlock down-sample component 1102 increases the resolution of the input image by a factor of 2.

Other implementations perform the operations of the motion up-sampler 1118 using different logic than that described above. For example, other implementations combine two or more components described above into a single component. Alternatively, or in addition, other implementations use different types components than those forth above, e.g., using interpolation components to replace one or more of the components shown in FIGS. 13 and 14.

### E. Training System

FIG. 15 provides further details on the operation of the training component 116 of the training system 112. The training component 116 iteratively updates the weights 114 of the predicting system 104 based on video sequences in a data store 118 that make up a training set.

An updating operation proceeds as follows with respect to an illustrative sequence of two or more given frames 1502 obtained from the data store 118. The predicting system 104 maps the given frames 1502 into a predicted frame 1504, guided by the weights 114 in their current form. A loss-generating component 1506 determines the difference between the predicted frame 1504 and a ground-truth frame 1508 obtained from the data store 118, to provide loss information. The ground-truth frame is the frame that actually follows the given frames 1502. A weight-updating component 1510 updates the weights 114 based on the loss information. The loss-generating component 1506 uses any loss function to provide the loss information, including any of mean square error (MSE), L1, perceptual similarity, etc., or any combination thereof. In some implementations, the weight-updating component 1510 uses stochastic gradient descent in combination with back-propagation to update the weights 114. The above-described process can be characterized as end-to-end training insofar as the weights of the entire model are updated based on the loss information computed based on the output of the model.

In some implementations, the training system 112 uses the following hyperparameters: image feature length is 16 (which is a characteristic of the image encoder 402); tendency vector length is 16 or 32; location vector length is 4; number of graph views is 4; k is 8 or 10; and the epochs of training are 100-300. This combination of parameters promotes efficient learning. Other implementations use other hyperparameter settings to achieve different training and/or performance objectives.

### F. Illustrative Performance of the Predicting System

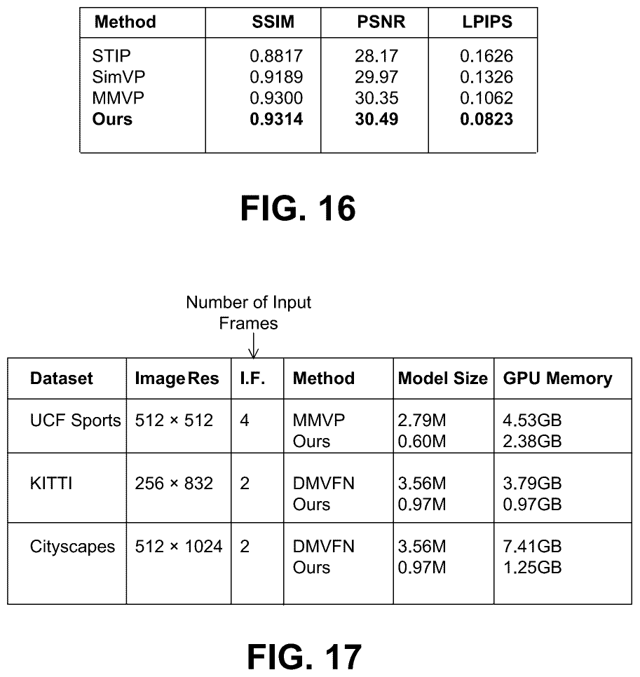

FIG. 16 is a chart showing the accuracy of the predicting system 104 of FIG. 1 (corresponding to “ours” in FIG. 16), relative to the accuracy of other prediction techniques. The other prediction techniques are: (1) the STIP model described in Chang, et al., “STIP: A SpatioTemporal Information-Preserving and Perception-Augmented Model for High-Resolution Video Prediction,” arXiv, arXiv:2206.04381v1 [cs.CV], Jun. 9, 2022, 12 pages; (2) the SimVP model described in Gao, et al., “SimVP: Simpler yet Better Video Prediction,” in Proceedings of the IEEE/CVF Conference on Computer Vision and Pattern Recognition, 2022, pp. 3170-3180; and (3) the MMVP model described in Zhong, et al., “MMVP: Motion-Matrix-based Video Prediction,” in Proceedings of the IEEE/CVF International Conference on Computer Vision, October 2023, pp. 4273-4283. The performance of the models is gauged by a Structural Similarity Index Measure (SSIM), a peak signal-to-noise ratio (PSNR) measure, and a learned perceptual similarity (LPIPS) measure.

As shown, the predicting system 104 (“ours”) provides output results that are better than or comparable to competing techniques. One factor that contributes to the accuracy of the predicting system 104 is its use of a robust set of spatiotemporal edges that model different types of semantic relationships among the image patches. The different categories of edges effectively capture the complex dynamics of movement, improving both the performance and efficiency of the predicting system 104 during training and inference.

Further, the prediction's system's use of k dynamic vectors per pixel improves prediction results, compared to, for instance, optical flow methods that perform analysis based on single hypothesized trajectory per pixel. In part, this improvement results from increased error tolerance through the consideration of plural candidate trajectories. Increasing k increases accuracy until a saturation point is reached, at which further improvement does not warrant the accompanying increase in the consumption of system resources.

The predicting system 104 also produces satisfactory results for challenging input conditions, including any of: motion blur; complex scenes including plural moving objects; distortion due to perspective projection; and/or poor or unstable lighting conditions.

Although not shown, the predicting system 104 is also successful in predicting subsequent future frames (not just the next frame t+1 after the last given frame). For instance, using structural similarity as the performance metric, the predicting system 104 achieves a score of 94.85 for the synthesized frame at t+1, 87.82 at t+3, and 82.11 at t+5. This is better than or competitive with other techniques. The structural similarity for t+3 is performed by averaging the scores for t+1, t+2, and t+3. The same applies to the structural similarity for t+5 (meaning that it is generated by averaging five different scores).

FIG. 17 is a chart that shows the resource efficiency of the predicting system 104 for different commercially available data sets (UCF Sports, KITTI, and Cityscapes), and different numbers of input frames (I.F.). The referenced DMVEN model is described in Hu, et al., “A Dynamic Multi-Scale Voxel Flow Network for Video Prediction,” arXiv, arXiv:2303.09875v2 [cs.CV], Mar. 24, 2023, 14 pages. As indicated in FIG. 17, the model that implements the predicting system 104 is significantly smaller than the competing systems. The model that implements the predicting system 104 also consumes significantly less GPU memory compared to the other systems (measured as maximum of running GPU memory). Overall, in some examples, the model achieves a reduction of model size by 78% and a decrease in GPU memory utilization by 47%. One factor that contributes to the resource efficiency of the predicting system 104 is the use of a sparse graph, e.g., which is constructed by only considering the k most significant semantic relations in each edge category. Further, the predicting system 104 uses a more streamlined and resource-efficient architecture compared to competing techniques, e.g., by replacing complex multi-layer convolutional layers with linear operations.

### G. Illustrative Process Flows

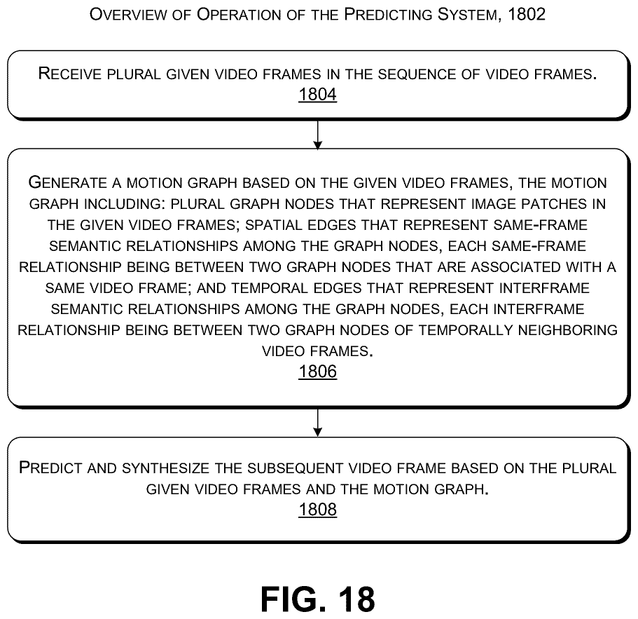

FIGS. 18-20 show three processes that represent an overview of the operation of the computing system of FIG. 1. Each of the processes is expressed as a series of operations performed in a particular order. But the order of these operations is merely representative, and the operations are capable of being varied in other implementations. Further, any two or more operations described below are capable of being performed in a parallel manner. In one implementation, the blocks shown in the processes that pertain to processing-related functions are implemented by the computing equipment described in connection with FIGS. 21 and 22.

More specifically, FIG. 18 shows a process 1802 that provides an overview of the operation of the predicting system 104 of FIG. 1. In block 1804, the predicting system 104 receives plural given video frames in the sequence of video frames. In block 1804, the predicting system 104 generates a motion graph based on the given video frames. The motion graph includes: plural graph nodes that represent image patches in the given video frames; spatial edges that represent same-frame semantic relationships among the graph nodes, each same-frame relationship being between two graph nodes that are associated with a same video frame; and temporal edges that represent interframe semantic relationships among the graph nodes, each interframe relationship being between two graph nodes of temporally neighboring video frames. In block 1806, the predicting system 104 predicts and synthesizes the subsequent video frame based on the plural given video frames and the motion graph.

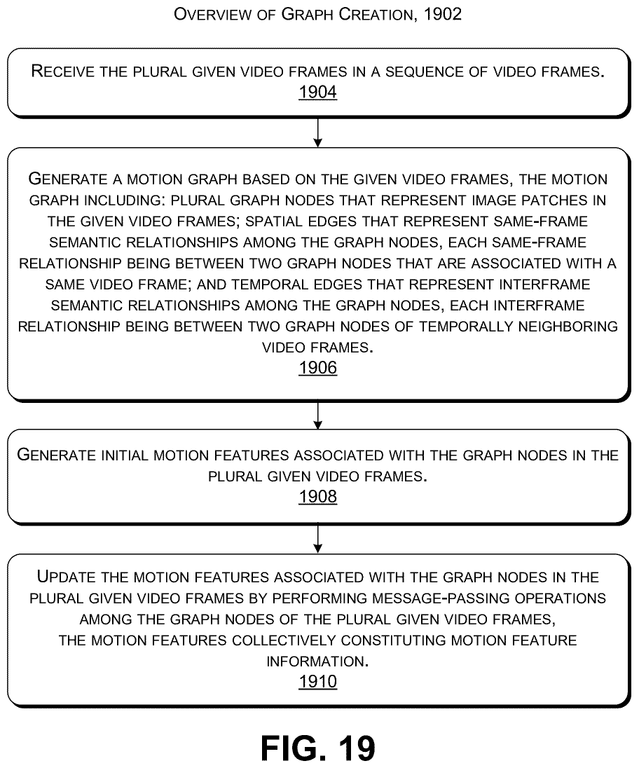

FIG. 19 shows process 1902 that provides an overview of a graph-creating operation performed by the predicting system 104 of FIG. 1. In block 1904, the predicting system 104 receives the plural given video frames in a sequence of video frames. In block 1906, the predicting system 104 generates a motion graph based on the given video frames. The motion graph includes: plural graph nodes that represent image patches in the given video frames; spatial edges that represent same-frame semantic relationships among the graph nodes, each same-frame relationship being between two graph nodes that are associated with a same video frame; and temporal edges that represent interframe semantic relationships among the graph nodes, each interframe relationship being between two graph nodes of temporally neighboring video frames. In block 1908, the predicting system 104 generates initial motion features associated with the graph nodes in the plural given video frames. In block 1910, the predicting system 104 updates the motion features associated with the graph nodes in the plural given video frames by performing message-passing operations among the graph nodes of the plural given video frames, the motion features collectively constituting motion feature information.

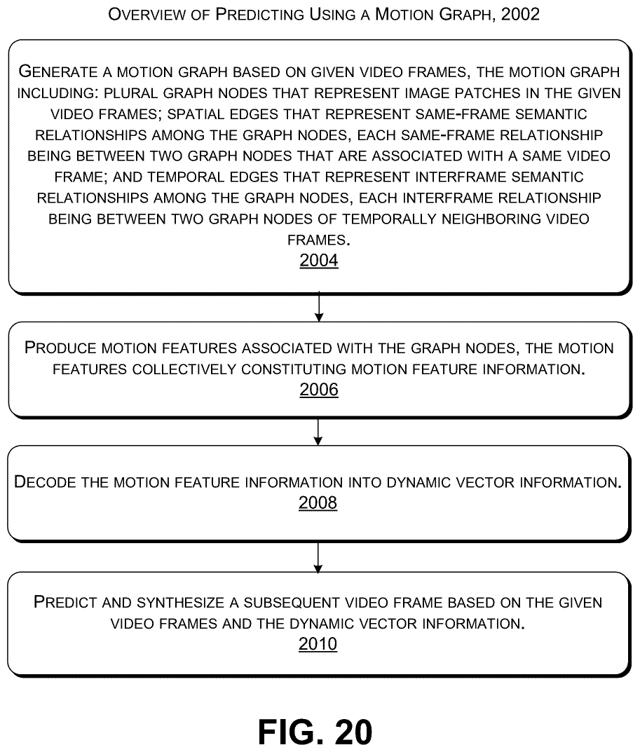

FIG. 20 shows a process 2002 that describes how the predicting system 104 of FIG. 1 predicts and synthesizes a future frame. In block 2004, the predicting system 104 generates a motion graph based on given video frames. The motion graph includes: plural graph nodes that represent image patches in the given video frames; spatial edges that represent same-frame semantic relationships among the graph nodes, each same-frame relationship being between two graph nodes that are associated with a same video frame; and temporal edges that represent interframe semantic relationships among the graph nodes, each interframe relationship being between two graph nodes of temporally neighboring video frames. In block 2006, the predicting system 104 produces motion features associated with the graph nodes, the motion features collectively constituting motion feature information. In block 2008, the predicting system 104 decodes the motion feature information into dynamic vector information. In block 2010, the predicting system 104 predicts and synthesizes a subsequent video frame based on the given video frames and the dynamic vector information.

### H. Illustrative Computing Logic

FIG. 21 shows computing equipment 2102 that, in some implementations, is used to implement the computing system 102. The computing equipment 2102 includes a set of local devices 2104 coupled to a set of servers 2106 via a computer network 2108. Each local device corresponds to any type of computing device, including any of a desktop computing device, a laptop computing device, a handheld computing device of any type (e.g., a smartphone or a tablet-type computing device), a mixed reality device, an intelligent appliance, a wearable computing device (e.g., a smart watch), an Internet-of-Things (IoT) device, a gaming system, a vehicle-borne computing system, any type of robot computing system, a computing system in a manufacturing system, etc. In some implementations, the computer network 2108 is implemented as a local area network, a wide area network (e.g., the Internet), one or more point-to-point links, or any combination thereof.

The bottom-most overlapping box in FIG. 21 indicates that the functionality of the computing system 102 is capable of being spread across the local devices 2104 and/or the servers 2106 in any manner. For instance, in one example, the predicting system 104 is entirely implemented by a local device. In another example, the functions of the predicting system 104 are entirely implemented by the servers 2106. Here, a user is able to interact with the servers 2106 via a browser application running on a local device. In other examples, some of the functions of the predicting system 104 are implemented by a local device, and other functions of the computing system 102 are implemented by the servers 2106. The training system 112 can likewise be spread across the local devices 2104 and/or servers in any manner.

FIG. 22 shows a computing system 2202 that, in some implementations, is used to implement any aspect of the mechanisms set forth in the above-described figures. For instance, in some implementations, the type of computing system 2202 shown in FIG. 22 is used to implement any local computing device or any server shown in FIG. 21. In all cases, the computing system 2202 represents a physical and tangible processing mechanism.

The computing system 2202 includes a processing system 2204 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 2202 also includes computer-readable storage media 2206, corresponding to one or more computer-readable media hardware units. The computer-readable storage media 2206 retains any kind of information 2208, such as machine-readable instructions, settings, model weights, and/or other data. In some implementations, the computer-readable storage media 2206 includes one or more solid-state devices, one or more hard disks, one or more optical disks, etc. Any instance of the computer-readable storage media 2206 represents a fixed or removable unit of the computing system 2202. Further, any instance of the computer-readable storage media 2206 provides volatile and/or non-volatile retention of information. The specific term “computer-readable storage medium” or “storage device” expressly excludes propagated signals per se in transit; a computer-readable storage medium or storage device is “non-transitory” in this regard.

The computing system 2202 utilizes any instance of the computer-readable storage media 2206 in different ways. For example, in some implementations, any instance of the computer-readable storage media 2206 represents a hardware memory unit (such as random access memory (RAM)) for storing information during execution of a program by the computing system 2202, and/or a hardware storage unit (such as a hard disk) for retaining/archiving information on a more permanent basis. In the latter case, the computing system 2202 also includes one or more drive mechanisms 2210 (such as a hard drive mechanism) for storing and retrieving information from an instance of the computer-readable storage media 2206.

In some implementations, the computing system 2202 performs any of the functions described above when the processing system 2204 executes computer-readable instructions stored in any instance of the computer-readable storage media 2206. For instance, in some implementations, the computing system 2202 carries out computer-readable instructions to perform each block of the processes described with reference to FIGS. 15 and 16. FIG. 22 generally indicates that hardware logic circuitry 2212 includes any combination of the processing system 2204 and the computer-readable storage media 2206.

In addition, or alternatively, the processing system 2204 includes one or more other configurable logic units that perform operations using a collection of logic gates, such as field-programmable gate arrays (FPGAs), etc. In these implementations, the processing system 2204 effectively incorporates a storage device that stores computer-readable instructions, insofar as the configurable logic units are configured to execute the instructions and therefore embody or store these instructions.

In some cases (e.g., in the case in which the computing system 2202 represents a user computing device), the computing system 2202 also includes an input/output interface 2214 for receiving various inputs (via input devices 2216), and for providing various outputs (via output devices 2218). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 2220 and an associated graphical user interface presentation (GUI) 2222. The display device 2220 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 2202 also includes one or more network interfaces 2224 for exchanging data with other devices via one or more communication conduits 2226. One or more communication buses 2228 communicatively couple the above-described units together.

The communication conduit(s) 2226 is implemented in any manner, e.g., by a local area computer network, a wide area computer network (e.g., the Internet), point-to-point connections, or any combination thereof. The communication conduit(s) 2226 include any combination of hardwired links, wireless links, routers, gateway functionality, name servers, etc., governed by any protocol or combination of protocols.

FIG. 22 shows the computing system 2202 as being composed of a discrete collection of separate units. In some cases, the collection of units corresponds to discrete hardware units provided in a computing device chassis having any form factor. FIG. 22 shows illustrative form factors in its bottom portion. In other cases, the computing system 2202 includes a hardware logic unit that integrates the functions of two or more of the units shown in FIG. 22. For instance, in some implementations, the computing system 2202 includes a system on a chip (SoC or SOC), corresponding to an integrated circuit that combines the functions of two or more of the units shown in FIG. 22.

The following summary provides a set of illustrative examples of the technology set forth herein.
(A1) According to one aspect, a method (e.g., the process 1802) is described for predicting a subsequent video frame in a sequence of video frames. The method includes receiving (e.g., in block 1804) plural given video frames in the sequence of video frames and generating (e.g., in block 1806) a motion graph based on the given video frames. The motion graph includes: plural graph nodes that represent image patches in the given video frames; spatial edges that represent same-frame semantic relationships among the graph nodes, each same-frame relationship being between two graph nodes that are associated with a same video frame; and temporal edges that represent interframe semantic relationships among the graph nodes, each interframe relationship being between two graph nodes of temporally neighboring video frames. The method further includes predicting and synthesizing (e.g., in block 1808) the subsequent video frame based on the plural given video frames and the motion graph.
(A2) According to some implementations of the method of A1, the method further includes: generating plural instances of frame feature information based on the plural given video frames; and generating plural sets of spatial edges and temporal edges for the plural instances of frame feature information, respectively.
(A3) According to some implementations of the methods of A1 or A2, the temporal edges include: backward temporal edges, each backward temporal edge representing a relationship between a particular graph node in a particular given video frame and a graph node in a temporally preceding video frame; and forward temporal edges, each forward edge representing a relationship between the particular graph node in the particular given video frame and a graph node in a temporally succeeding video frame.
(A4) According to some implementations of the method of A3, for the particular graph node, the method identifies a prescribed number of spatial edges, a prescribed number of backward temporal edges, and a prescribed number of forward temporal edges.
(A5) According to some implementations of any of the methods of A1-A4, with respect to a particular graph node associated with a particular image patch, each edge is produced by: generating semantic matching scores that describe semantic relationships between the particular image patch and other image patches; identifying, based on the semantic matching scores, a prescribed number of the other image patches that are closest matches to the particular image patch; and establishing edges between the particular graph node and graph nodes associated with the prescribed number of other image patches.
(A6) According to some implementations of the method of A1, the generating of the motion graph includes: generating initial motion features associated with the graph nodes in the plural given video frames; and updating the motion features associated with the graph nodes in the plural given video frames by performing message-passing operations among the graph nodes of the plural given video frames, the motion features collectively constituting motion feature information.
(A7) According to some implementations of the method of A6, the method further includes performing plural iterations of the message-passing operations.
(A8) According to some implementations of the method of A7, in a particular iteration of the message-passing operations, the method includes: updating motion features for graph nodes connected via the spatial edges; updating motion features for graph nodes connected via forward temporal edges, each forward temporal edge representing a relationship between a graph node in a particular given video frame and a graph node in a temporally succeeding video frame; again updating the motion features for the graph nodes connected via the spatial edges; and updating motion features for graph nodes connected via backward temporal edges, each backward temporal edge representing a relationship between the graph node in the particular given video frame and a graph node in a temporally preceding video frame.
(A9) According to some implementations of any of the methods of A1-A8, the method includes: generating plural instances of motion feature information associated with plural different feature representations of the plural given video frames that include different respective sets of edges; and consolidating the plural instances of motion feature information into a single instance of motion feature information.
(A10) According to some implementations of any of the methods of A1-A9, the method includes up-sampling motion feature information associated with the motion graph, to produce up-sampled motion feature information. The predicting of the subsequent video frame is performed for individual pixels based on the up-sampled motion feature information.
(A11) According to some implementations of any of the methods of A1-A10, the predicting of the subsequent video frame includes: decoding motion feature information associated with the motion graph into dynamic vector information; and predicting the subsequent video frame based on the given video frames and the dynamic vector information.
(A12) According to some implementations of the method of A11, the dynamic vector information includes, for a particular source pixel under consideration associated with a particular given video frame, plural dynamic vectors, each dynamic vector connecting the particular source pixel to a particular target pixel in the subsequent video frame.
(A13) According to some implementations of the method of A12, plural source pixels in the plural given video frames map to a particular target pixel in the subsequent video frame, and wherein the method further comprises generating image content associated with the particular target pixel based on weighted contributions from the plural source pixels.
(A14) According to some implementations of any of the methods of A1-A13, the method further includes performing an application function based on the subsequent video frame that is predicted.
(B1) According to another aspect, a method (e.g., the process 1902) is described for processing plural given video frames. The method includes receiving (e.g., in block 1904) the plural given video frames in a sequence of video frames and generating (e.g., in block 1906) a motion graph based on the given video frames. The motion graph includes: plural graph nodes that represent image patches in the given video frames; spatial edges that represent same-frame semantic relationships among the graph nodes, each same-frame relationship being between two graph nodes that are associated with a same video frame; and temporal edges that represent interframe semantic relationships among the graph nodes, each interframe relationship being between two graph nodes of temporally neighboring video frames. The method further includes generating (e.g., in block 1908) initial motion features associated with the graph nodes in the plural given video frames, and updating (e.g., in block 1910) the motion features associated with the graph nodes in the plural given video frames by performing message-passing operations among the graph nodes of the plural given video frames. The motion features collectively constitute motion feature information.
(C1) According to another aspect, a method (e.g., the process 2002) is described for processing given video frames. The method includes (e.g., in block 2004) generating a motion graph based on the given video frames. The motion graph includes: plural graph nodes that represent image patches in the given video frames; spatial edges that represent same-frame semantic relationships among the graph nodes, each same-frame relationship being between two graph nodes that are associated with a same video frame; and temporal edges that represent interframe semantic relationships among the graph nodes, each interframe relationship being between two graph nodes of temporally neighboring video frames. The method further includes: producing (e.g., in block 2004) motion features associated with the graph nodes, the motion features collectively constituting motion feature information; decoding (e.g., in block 2006) the motion feature information into dynamic vector information; and predicting and synthesizing (e.g., in block 2008) a subsequent video frame based on the given video frames and the dynamic vector information.

In yet another aspect, some implementations of the technology described herein include a computing system (e.g., the computing system 2202) that includes a processing system (e.g., the processing system 2204) having a processor. The computing system also includes a storage device (e.g., the computer-readable storage media 2206) for storing computer-readable instructions (e.g., the information 2208). The processing system executes the computer-readable instructions to perform any of the methods described herein (e.g., any individual method of the methods of A1-A14, B1, and C1).

In yet another aspect, some implementations of the technology described herein include a computer-readable storage medium (e.g., the computer-readable storage media 2206) for storing computer-readable instructions (e.g., the information 2208). A processing system (e.g., the processing system 2204) executes the computer-readable instructions to perform any of the operations described herein (e.g., the operations in any individual method of the methods of A1-A14, B1, and C2).

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

This description may have identified one or more features as optional. This type of statement is not to be interpreted as an exhaustive indication of features that are to be considered optional; generally, any feature is to be considered as an example, although not explicitly identified in the text, unless otherwise noted. Further, any features described as alternative ways of carrying out identified functions or implementing identified mechanisms are also combinable together in any combination, unless otherwise noted.

In terms of specific terminology, the phrase “configured to” encompasses various physical and tangible mechanisms for performing an identified operation. The mechanisms are configurable to perform an operation using the hardware logic circuitry 2212 of FIG. 22. The term “logic” likewise encompasses various physical and tangible mechanisms for performing a task. For instance, each processing-related operation illustrated in the flowcharts of FIGS. 21 and 22 corresponds to a logic component for performing that operation.

Further, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. The term “prescribed” is used to designate that something is purposely chosen according to any environment-specific considerations. For instance, a threshold value or state is said to be prescribed insofar as it is purposely chosen to achieve a desired result. “Environment-specific” means that a state is chosen for use in a particular environment. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for predicting a subsequent video frame in a sequence of video frames, comprising:
receiving plural given video frames in the sequence of video frames;
generating a motion graph based on the given video frames, the motion graph including:
plural graph nodes that represent image patches in the given video frames;
spatial edges that represent same-frame semantic relationships among the graph nodes, each same-frame relationship being between two graph nodes that are associated with a same video frame; and
temporal edges that represent interframe semantic relationships among the graph nodes, each interframe relationship being between two graph nodes of temporally neighboring video frames; and
predicting and synthesizing the subsequent video frame based on the plural given video frames and the motion graph.

2. The method of claim 1, further comprising:
generating plural instances of frame feature information based on the plural given video frames; and
generating plural sets of spatial edges and temporal edges for the plural instances of frame feature information, respectively.

3. The method of claim 1, wherein the temporal edges include:
backward temporal edges, each backward temporal edge representing a relationship between a particular graph node in a particular given video frame and a graph node in a temporally preceding video frame; and
forward temporal edges, each forward edge representing a relationship between the particular graph node in the particular given video frame and a graph node in a temporally succeeding video frame.

4. The method of claim 3, wherein, for the particular graph node, the method identifies a prescribed number of spatial edges, a prescribed number of backward temporal edges, and a prescribed number of forward temporal edges.

5. The method of claim 1, wherein, with respect to a particular graph node associated with a particular image patch, each edge is produced by:
generating semantic matching scores that describe semantic relationships between the particular image patch and other image patches;
identifying, based on the semantic matching scores, a prescribed number of the other image patches that are closest matches to the particular image patch; and
establishing edges between the particular graph node and graph nodes associated with the prescribed number of other image patches.

6. The method of claim 1, wherein the generating of the motion graph comprises:
generating initial motion features associated with the graph nodes in the plural given video frames; and
updating the motion features associated with the graph nodes in the plural given video frames by performing message-passing operations among the graph nodes of the plural given video frames,
the motion features collectively constituting motion feature information.

7. The method of claim 6, further comprising performing plural iterations of the message-passing operations.

8. The method of claim 7, wherein, in a particular iteration of the message-passing operations, the method comprises:
updating motion features for graph nodes connected via the spatial edges;
updating motion features for graph nodes connected via forward temporal edges, each forward temporal edge representing a relationship between a graph node in a particular given video frame and a graph node in a temporally succeeding video frame;
again updating the motion features for the graph nodes connected via the spatial edges; and
updating motion features for graph nodes connected via backward temporal edges, each backward temporal edge representing a relationship between the graph node in the particular given video frame and a graph node in a temporally preceding video frame.

9. The method of claim 1, further comprising:
generating plural instances of motion feature information associated with plural different feature representations of the plural given video frames that include different respective sets of edges; and
consolidating the plural instances of motion feature information into a single instance of motion feature information.

10. The method of claim 1, further comprising:
up-sampling motion feature information associated with the motion graph, to produce up-sampled motion feature information,
wherein the predicting of the subsequent video frame is performed for individual pixels based on the up-sampled motion feature information.

11. The method of claim 1, wherein the predicting of the subsequent video frame comprises:
decoding motion feature information associated with the motion graph into dynamic vector information; and
predicting the subsequent video frame based on the given video frames and the dynamic vector information.

12. The method of claim 11, wherein the dynamic vector information includes, for a particular source pixel under consideration associated with a particular given video frame, plural dynamic vectors, each dynamic vector connecting the particular source pixel to a particular target pixel in the subsequent video frame.

13. The method of claim 12, wherein plural source pixels in the plural given video frames map to a particular target pixel in the subsequent video frame, and wherein the method further comprises generating image content associated with the particular target pixel based on weighted contributions from the plural source pixels.

14. The method of claim 1, further comprising performing an application function based on the subsequent video frame that is predicted.

15. A computing system for processing plural given video frames, comprising:
an instruction data store for storing computer-readable instructions; and
a processing system for executing the computer-readable instructions in the data store, to perform operations including:
receiving the plural given video frames in a sequence of video frames;
generating a motion graph based on the given video frames, the motion graph including:
plural graph nodes that represent image patches in the given video frames;
spatial edges that represent same-frame semantic relationships among the graph nodes, each same-frame relationship being between two graph nodes that are associated with a same video frame; and
temporal edges that represent interframe semantic relationships among the graph nodes, each interframe relationship being between two graph nodes of temporally neighboring video frames;
generating initial motion features associated with the graph nodes in the plural given video frames; and
updating the motion features associated with the graph nodes in the plural given video frames by performing message-passing operations among the graph nodes of the plural given video frames,
the motion features collectively constituting motion feature information.

16. The computing system of claim 15, wherein the temporal edges include:
backward temporal edges, each backward temporal edge representing a relationship between a particular graph node in a particular given video frame and a graph node in a temporally preceding video frame; and
forward temporal edges, each forward edge representing a relationship between the particular graph node in the particular given video frame and a graph node in a temporally succeeding video frame,
wherein, for the particular graph node, the operations identify a prescribed number of spatial edges, a prescribed number of backward temporal edges, and a prescribed number of forward temporal edges.

17. The computing system of claim 15, wherein, with respect to a particular graph node associated with a particular image patch, each edge is produced by:
generating semantic matching scores that describe semantic relationships between the particular image patch and other image patches;
identifying a prescribed number of the other image patches that are closest matches to the particular image patch; and
establishing edges between the particular graph node and graph nodes associated with the prescribed number of other image patches.

18. A computer-readable storage medium for storing computer-readable instructions, a processing system executing the computer-readable instructions to perform operations, the operations comprising each of:
generating a motion graph based on given video frames, the motion graph including:
plural graph nodes that represent image patches in the given video frames;
spatial edges that represent same-frame semantic relationships among the graph nodes, each same-frame relationship being between two graph nodes that are associated with a same video frame; and
temporal edges that represent interframe semantic relationships among the graph nodes, each interframe relationship being between two graph nodes of temporally neighboring video frames;
producing motion features associated with the graph nodes, the motion features collectively constituting motion feature information;
decoding the motion feature information into dynamic vector information; and
predicting and synthesizing a subsequent video frame based on the given video frames and the dynamic vector information.

19. The computer-readable storage medium of claim 18, wherein the dynamic vector information includes, for a particular source pixel under consideration associated with a particular given video frame, plural dynamic vectors, each dynamic vector connecting the particular source pixel to a particular target pixel in the subsequent video frame.

20. The computer-readable storage medium of claim 19, wherein plural source pixels in the plural given video frames map to a particular target pixel in the subsequent video frame, and wherein the method further comprises generating image content associated with the particular target pixel based on weighted contributions from the plural source pixels.
